(19) United States
(12) Patent Application Publication
(10) Pub. No.: US 2022/0385211 A1
(43) Pub. Date: Dec. 1, 2022

(54) INVERTER CIRCUIT FOR VEHICLES

(71) Applicant: HYUNDAI MOBIS Co., Ltd., Seoul (KR)

(72) Inventors: Tae Eun JANG, Ansan-si (KR); Pil Kyoung OH, Gunpo-si (KR)

(73) Assignee: HYUNDAI MOBIS Co., Ltd., Seoul (KR)

(21) Appl. No.: 17/723,588

(22) Filed: Apr. 19, 2022

(30) Foreign Application Priority Data
May 25, 2021 (KR) 10-2021-0067299

(51) Int. Cl. H02M 7/5387; H02P 27/06; B60L 53/20

(52) U.S. Cl. CPC H02M 7/53871; H02P 27/06; B60L 53/20; B60L 2210/40

(57) ABSTRACT

A vehicle inverter circuit includes a first inverter and a second inverter connected to a motor, a mode conversion switching element configured to short-circuit or open the first inverter and the second inverter based on a switching operation to drive the motor in one of a Y-winding driving mode and an open-end winding driving mode, and a controller configured to control a switching operation of the mode conversion switching element.

### CROSS-REFERENCE TO RELATED APPLICATIONS

This application claims the benefit under 35 USC § 119(a) oft Korean Patent Application No. 10-2021-0067299, filed on May 25, 2021, in the Korean Intellectual Property Office, the entire disclosure of which is incorporated herein by reference for all purposes.

### BACKGROUND

### 1. Field

The following description relates to an inverter circuit for vehicles, and more particularly, to an inverter circuit implemented in electric vehicles.

### 2. Description of Related Art

Electric vehicles (EVs) and hybrid electric vehicles (HEVs) are supplied with power from a motor driven by an inverter. Motors may be largely classified into a Y-winding method or an open-end winding method on the basis of a winding method.

In the Y-winding method, a single inverter is used, and in the open-end winding method, a double inverter (two inverters) is used. The Y-winding method enables motors to be used with high efficiency, and the open-end winding method enables motors to be used with high power.

As described above, in the Y-winding method, motors may be used with high efficiency, but may not be used with high power. In the open-end winding method, motors may be used with high power, but may not be used with high efficiency. This is because a hardware configuration based on a Y-winding structure differs from a hardware configuration based on an open-end winding structure.

EVs and HEVs, because the efficiency of a vehicle is important in a low speed, the Y-winding method is advantageous, and because power is important in a high speed, the open-end winding method is advantageous. Therefore, a method for satisfying two advantages is needed, but is not developed yet.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, a vehicle inverter circuit includes a first inverter and a second inverter configured to be connected to a motor; a mode conversion switching element configured to short-circuit or open the first inverter and the second inverter based on a switching operation to drive the motor in one of a Y-winding driving mode and an open-end winding driving mode; and a controller configured to control the switching operation of the mode conversion switching element.

Each of the first inverter and the second inverter may include a plurality of switching element pairs connected to each other in parallel, wherein each of the plurality of switching element pairs comprises an upper switching element connected to an anode of a direct current power source, and a lower switching element connected to a cathode of the direct current power source, wherein lower switching elements of the first inverter are connected to a second terminal of the mode conversion switching element in common, and wherein lower switching elements of the second inverter are connected to a first terminal of the mode conversion switching element in common.

In the Y-winding driving mode, based on a control operation performed by the controller, all of the upper switching elements of the second inverter are turned off, all of the lower switching elements of the second inverter are turned on, and the mode conversion switching element is turned off.

In the Y-winding driving mode, the mode conversion switching element may be turned on based on a control operation performed by the controller.

In a general aspect, a vehicle inverter circuit operating method includes applying a control signal to a mode conversion switching element by implementing a controller configured to control a switching operation of the mode conversion switching element which is configured to short-circuit or open a first inverter and a second inverter connected to a motor; and driving the motor in one of a Y-winding driving mode and an open-end winding driving mode when the mode conversion switching element performs a switching operation based on the control signal.

Each of the first inverter and the second inverter may include a plurality of switching element pairs connected to each other in parallel, wherein each of the plurality of switching element pairs comprises an upper switching element connected to an anode of a direct current power source, and a lower switching element connected to a cathode of the direct current power source, and wherein the applying of the control signal comprises, in the Y-winding driving mode, turning off all of upper switching elements of the second inverter, turning on all of lower switching elements of the second inverter, and applying the control signal to implement the turning off of the upper switching elements with the mode conversion switching element.

Each of the first inverter and the second inverter comprises a plurality of switching element pairs connected to each other in parallel, wherein each of the plurality of switching element pairs comprises an upper switching element connected to an anode of a direct current power source and a lower switching element connected to a cathode of the direct current power source, and the applying of the control signal comprises, in the open-end winding driving mode, applying the control signal to perform a turn-on operation by implementing the mode conversion switching element.

Other features and aspects will be apparent from the following detailed description, the drawings, and the claims.

### BRIEF DESCRIPTION OF DRAWINGS

FIG. 1 is a whole circuit diagram of a motor based on a Y-winding method implementing a single inverter.

FIG. 2 is a whole circuit diagram of a motor based on an open-end winding method implementing a double inverter.

FIG. 3 is an equivalent circuit diagram of an inverter circuit that implements all of a Y-winding driving mode and an open-end winding driving mode, in accordance with one or more embodiments.

FIG. 4 is an equivalent circuit diagram illustrating an example where switching elements turned on and switching elements turned off in a Y-winding driving mode are removed in the equivalent circuit diagram of FIG. 3.

FIG. 5 is an equivalent circuit diagram illustrating an example where switching elements turned on in an open-end winding driving mode are removed in the equivalent circuit diagram of FIG. 3.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness, noting that omissions of features and their descriptions are also not intended to be admissions of their general knowledge.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

The terminology used herein is for the purpose of describing particular examples only, and is not to be used to limit the disclosure. As used herein, the singular forms “a,” “an,” and “the” are intended to include the plural forms as well, unless the context clearly indicates otherwise. As used herein, the term “and/or” includes any one and any combination of any two or more of the associated listed items. As used herein, the terms “include,” “comprise,” and “have” specify the presence of stated features, numbers, operations, elements, components, and/or combinations thereof, but do not preclude the presence or addition of one or more other features, numbers, operations, elements, components, and/or combinations thereof.

In addition, terms such as first, second, A, B, (a), (b), and the like may be used herein to describe components. Each of these terminologies is not used to define an essence, order, or sequence of a corresponding component but used merely to distinguish the corresponding component from other component(s).

Unless otherwise defined, all terms, including technical and scientific terms, used herein have the same meaning as commonly understood by one of ordinary skill in the art to which this disclosure pertains and after an understanding of the disclosure of this application. Terms, such as those defined in commonly used dictionaries, are to be interpreted as having a meaning that is consistent with their meaning in the context of the relevant art and the disclosure of this application, and are not to be interpreted in an idealized or overly formal sense unless expressly so defined herein.

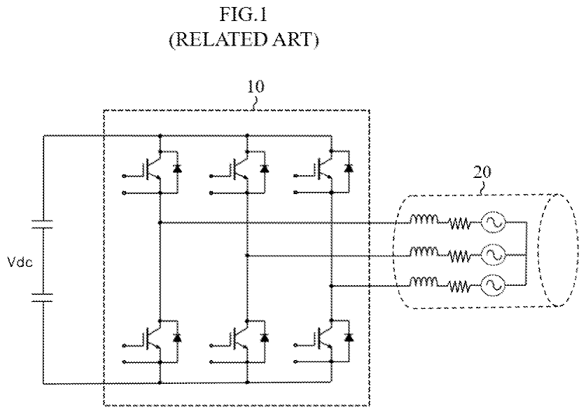

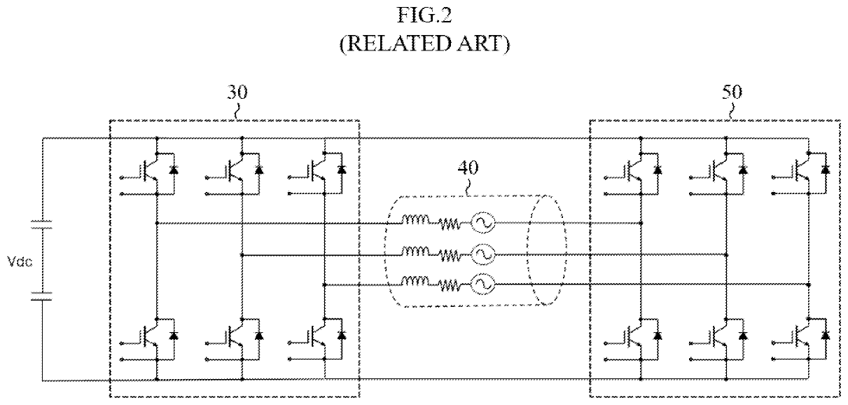

In order to help understand the examples, a motor (see FIG. 1) based on a Y-winding method using a single inverter 10 and a motor 20 (see FIG. 2) based on an open-end winding method using a double inverter will be briefly described below, and a structure of an inverter that drives all of a motor based on the Y-winding method and a motor based on the open-end winding method, in accordance with one or more embodiments, will be described below.

FIG. 1 is a whole circuit diagram of a motor based on a Y-winding method implementing a single inverter.

With regard to an equivalent circuit of the motor based on the Y-winding method implementing a single inverter, as illustrated in FIG. 1, a direct current (DC) power source Vdc, a single inverter 10, and a motor 20 may be provided.

The motor 20 may represent, for example, a permanent magnet synchronous motor (PMSM) and may use a Y-winding structure.

The single inverter 10 may include six power switching elements, an output voltage generated based on the turn-on/off of the six power switching elements may be supplied the motor 20, and the single inverter 10 may be driven with high efficiency by using a relatively small number of switching elements. In this case, an output voltage of the inverter 10 may be Vdc/\sqrt{3}.

FIG. 2 is a whole circuit diagram of a motor based on an open-end winding method using a double inverter.

With regard to an equivalent circuit of the motor based on the open-end winding method using a double inverter, as illustrated in FIG. 2, a first inverter 30 connected to a DC power source Vdc, a motor 40 connected to the first inverter 30, and a second inverter 50 connected to the motor 40 may be provided.

The motor 40 may represent, for example, a PMSM and may use an open-end winding structure.

Each of the first and second inverters 30 and 50 connected to both ends with the motor 40 therebetween may be configured with six power switching elements, and thus, the total number of switching elements may be twelve.

As twelve switching elements are turned on/off, the motor 40 may be driven with high power. In this case, an output voltage of an inverter may be Vdc.

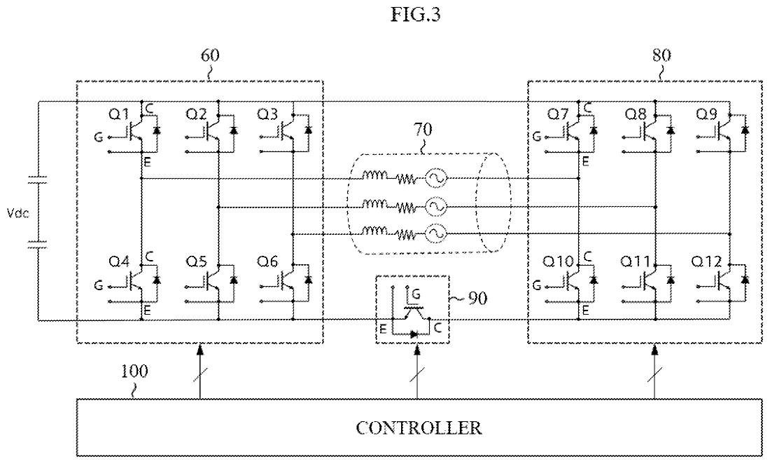

FIG. 3 is an equivalent circuit diagram of an inverter structure that implements all of the Y-winding method and the open-end winding method, in accordance with one or more embodiments.

Referring to FIG. 3, the inverter structure that implements all of the Y-winding method and the open-end winding method, in accordance with one or more embodiments, may include first and second inverters 60 and 80 connected to each other with a motor 70 therebetween, and a DC power source Vdc may be connected to the first inverter 60.

Each of the first and second inverters 60 and 80 may include six switching elements Q1 to Q6 or Q7 to Q12. Each switching element may be, for example, an insulated gate bipolar transistor (IGBT)-based power switching element, a silicon carbide (SiC)-based power switching element, or a gallium nitride (GaN)-based power switching element, but is not limited thereto.

The six switching elements Q1 to Q6 or Q7 to Q12 may have a structure where two switching elements serially connected to each other configure one pair and three pairs are connected to one another in parallel.

Herein, in each pair, the switching elements Q1, Q2, Q3, Q7, Q8, and Q9 illustrated in an upper region may each be referred to as an upper switching element, and the switching elements Q4, Q5, Q6, Q10, Q11, and Q12 illustrated in a lower region may each be referred to as a lower switching element.

The inverter structure that implements all of the Y-winding method and the open-end winding method, in accordance with one or more embodiments, may further include a mode conversion switching element 90 connected between the first and second inverters 60 and 80. The mode conversion switching element 90 may also be implemented with an IGBT, but is not limited thereto.

In detail, a first terminal of the mode conversion switching element 90 may be connected to the lower switching elements Q10, Q11, and Q12 of the second inverter 80, and a second terminal of the mode conversion switching element 90 may be connected to second terminals (for example, an emitter) of the lower switching elements Q4, Q5, and Q6 of the first inverter 60 in common.

In FIG. 3, a controller 100 is further illustrated, and the controller 100 may control the turn-on/off of the switching elements Q1 to Q12 and 90.

In detail, the controller 100 may generate a plurality of control signals to drive a Y-winding driving mode or an open-end winding driving mode and may apply the control signals to third terminals (a control terminal or a gate terminal) of corresponding switching elements.

For example, in the Y-winding driving mode, the controller 100 may output a plurality of control signals which turn on the lower switching elements Q10, Q11, and Q12 of the second inverter 80, turn off the upper switching elements Q7, Q8, and Q9 of the second inverter 80, and turn off the mode conversion switching element 90 connecting the first inverter 60 to the second inverter 80.

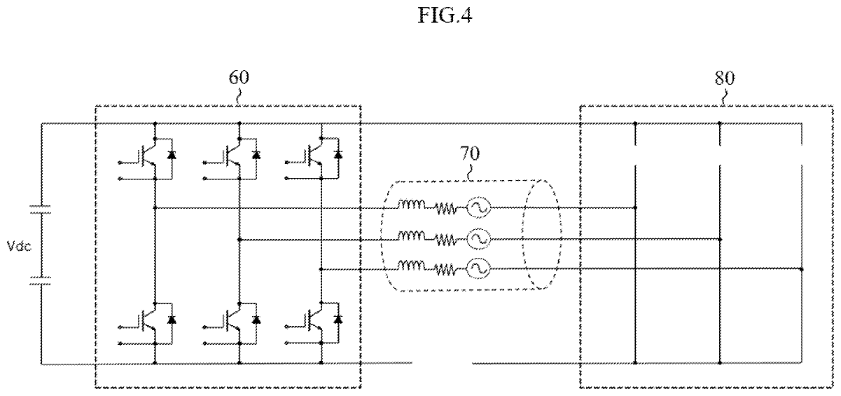

An equivalent circuit diagram of an inverter structure, where switching elements turned on and switching elements turned off in the Y-winding driving mode are removed, is illustrated in FIG. 4.

As illustrated in FIG. 4, it may be seen that the same equivalent circuit as that of the single inverter structure illustrated in FIG. 1 is implemented when the lower switching elements Q10, Q11, and Q12 of the second inverter 80 are turned on, the upper switching elements Q7, Q8, and Q9 of the second inverter 80 are turned off, and the mode conversion switching element 90 connecting the first inverter 60 to the second inverter 80 is turned off.

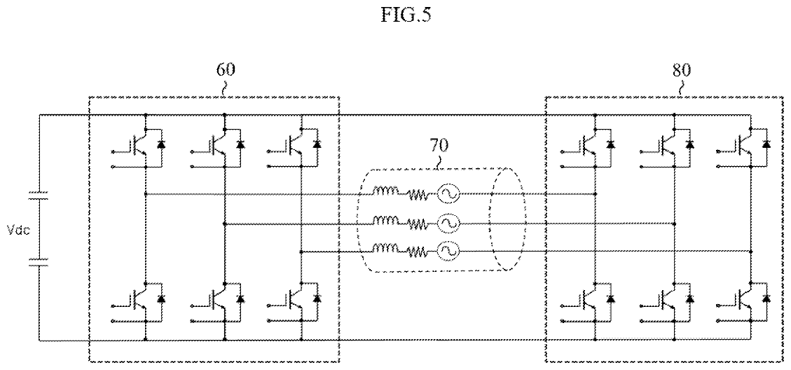

As another example, in the open-end winding driving mode, the controller 100 may output a control signal which turns on the switching element 90. An equivalent circuit diagram of an inverter structure, where the switching element 90 turned on in the open-end winding driving mode are removed, is illustrated in FIG. 5.

As illustrated in FIG. 5, it may be seen that the same equivalent circuit as that of the double inverter structure illustrated in FIG. 2 is implemented when the mode conversion switching element 90 is turned on.

As described above, by using an inverter structure, in accordance with one or more embodiments, when a vehicle is driving at a high speed, a motor may be driven based on an open-end winding and may be used with high power, and when the vehicle is driving at a low speed, the motor may be driven based on a Y-winding and may be used with high efficiency. Accordingly, requirements for high-speed driving and low-speed driving may be simultaneously satisfied.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A vehicle inverter circuit, the inverter circuit comprising:
a first inverter and a second inverter configured to be connected to a motor;
a mode conversion switching element configured to short-circuit or open the first inverter and the second inverter based on a switching operation to drive the motor in at least one of a Y-winding driving mode or an open-end winding driving mode; and
a controller configured to control the switching operation of the mode conversion switching element.

2. The inverter circuit of claim 1, wherein each of the first inverter and the second inverter comprises a plurality of switching element pairs connected to each other in parallel,
wherein each of the plurality of switching element pairs comprises an upper switching element connected to an anode of a direct current power source, and a lower switching element connected to a cathode of the direct current power source,
wherein lower switching elements of the first inverter are configured to be connected to a second terminal of the mode conversion switching element in common, and
wherein lower switching elements of the second inverter are configured to be connected to a first terminal of the mode conversion switching element in common.

3. The inverter circuit of claim 2, wherein, in the Y-winding driving mode, based on a control operation performed by the controller,
all of the upper switching elements of the second inverter are turned off,
all of the lower switching elements of the second inverter are turned on, and
the mode conversion switching element is turned off.

4. The inverter circuit of claim 2, wherein, in the Y-winding driving mode, the mode conversion switching element is turned on based on a control operation performed by the controller.

5. A vehicle inverter circuit operating method, the method comprising:
applying a control signal to a mode conversion switching element by implementing a controller configured to control a switching operation of the mode conversion switching element which is configured to short-circuit or open a first inverter and a second inverter connected to a motor; and
driving the motor in at least one of a Y-winding driving mode or an open-end winding driving mode when the mode conversion switching element performs a switching operation based on the control signal.

6. The operating method of claim 5, wherein each of the first inverter and the second inverter comprises a plurality of switching element pairs connected to each other in parallel,
wherein each of the plurality of switching element pairs comprises an upper switching element connected to an anode of a direct current power source, and a lower switching element connected to a cathode of the direct current power source, and
wherein the applying of the control signal comprises, in the Y-winding driving mode, turning off all of upper switching elements of the second inverter, turning on all of lower switching elements of the second inverter, and applying the control signal to implement the turning off of the upper switching elements with the mode conversion switching element.

7. The operating method of claim 5, wherein each of the first inverter and the second inverter comprises a plurality of switching element pairs connected to each other in parallel,
wherein each of the plurality of switching element pairs comprises an upper switching element connected to an anode of a direct current power source and a lower switching element connected to a cathode of the direct current power source, and
the applying of the control signal comprises, in the open-end winding driving mode, applying the control signal to perform a turn-on operation by implementing the mode conversion switching element.
